(19) United States
(12) Patent Application Publication
(10) Pub. No.: US 2024/0078382 A1
(43) Pub. Date: Mar. 7, 2024

(54) FREQUENT LOGIC-RULE SETS FOR ML-BASED DOCUMENT CONTENT EXTRACTION SUPPORT

(71) Applicant: Dell Products L.P., Round Rock, TX (US)

(72) Inventors: Vinicius Michel Gottin, Rio de Janeiro (BR); Paulo Abelha Ferreira, Rio de Janeiro (BR); Pablo Nascimento da Silva, Niterói (BR); Rômulo Teixeira de Abreu Pinho, Niterói (BR)

(21) Appl. No.: 17/929,497

(22) Filed: Sep. 2, 2022

(51) Int. Cl. G06F 40/226; G06N 5/02

(52) U.S. Cl. CPC G06F 40/226; G06N 5/025

(57) ABSTRACT

One example method includes receiving a rule-set, including a combination of rules, that was determined to occur in a set of ground truth documents, applying the rule-set to a new document that was not included in the set of ground truth documents, determining whether or not a rule in the rule-set succeeded or failed when applied to a word in the new document, and when the rule is determined to have failed, identifying the failed rule, identifying a confidence level in the determination that the rule failed, and when the confidence level is below a threshold confidence level, identifying the word, to which the failed rule was applied, as a candidate for verification by a human.

### COPYRIGHT OR MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### FIELD OF THE INVENTION

Embodiments of the present invention generally relate to extraction of content from documents. More particularly, at least some embodiments of the invention relate to systems, hardware, software, computer-readable media, and methods, for frequent itemset mining to determine frequent rule sets over the word-items in a new document from which content is to be extracted. Based on an assessment of which rules hold for cell item predictions for the new document, a determination may then be made as to which words in that document may require human revision.

### BACKGROUND

Information extraction from unstructured documents is an area of interest to many organizations. One essential aspect of organization document processing is the time and effort spent on reading and manually extracting information from unstructured documents. However, there are a variety of problems in this field that impair the effectiveness of information extraction efforts.

One such problem concerns the limitations of logic rule-based approaches due to layout variability. Particularly, documents may have different pre-defined table layouts, even considering the organization that produced the document. Table layouts may be similarly reused across different organizations. For example, every purchase order (PO) from company A has a layout A, with 3 columns, on the bottom of the page. In contrast, company B may generate documents using the layout A and a layout B, with 6 columns, on the center of the document. In other words, a model to extract information automatically will have difficulty generalizing across the documents of company A and company B since rule-based or template-based approaches are not expected to work for all documents. Still, such rules may be directly applicable to a substantial proportion of the documents in the domain.

In the specific case of identifying cell-items, these issues are prominent, with varying frequency, and aggravated by specific issues. Hence, while it seems generally possible to achieve a reasonable effectiveness using cell-item extraction with rule-based approaches, these cannot possibly account for the majority of cases, limiting their effectiveness. For example, documents may have different pre-defined table layouts and also have different words representing the header and content of the table. So, one cannot directly use keywords as anchors to discover the correct column of each word inside the table for all documents.

Another problem known to exist concerns the limitations of machine learning approaches due to challenging domain characteristics. In particular, the information extraction domain in general is difficult and plagued by issues of content variability and incompleteness.

These challenging characteristics include: table layout variability—tables come in many shapes and formats, with varying types of graphical markings and spacings; open-ended word content—it is difficult or impossible to know beforehand all the possible words that can be present in a table—further, variability in terminology, typology and graphical representation of words is also a challenge, as it is not trivial to determine line items based on word-contents and their graphical representations in the document, due to the high variability across documents, even documents from a common domain; unlimited number of items in the list—for instance, it is not possible to know the number of rows beforehand and, therefore, any automatic extraction method will need to be able to respond to an unlimited number of list items—furthermore, not all list items have the same number of elements, for example, not all rows in tables have values in all columns; and, variability in terminology, typology and graphical representation—it is difficult to determine line items based on word-contents and their graphical representations in the document, due to the high variability across documents, even documents from the same domain.

Thus, even striving for generality, machine learning (ML) methods tend to obtain imperfect accuracy for the cell-item determination for all word-elements in a document. This means that human intervention is still required even in the presence of automation methods. This is highlighted by the following problem, which concerns interpretability of machine learning results

In particular, it is noted that partially correct results, as described above, are already a good result, insofar as they minimize the amount of work a human annotator may need to perform. That is, the human annotator may only have to fix the cell-item predictions the approach got wrong, instead of annotating all the predictions. However, if interpretability could be provided, the review work of such human annotators could be targeted towards documents, and/or words within documents, that are most likely to require comprehensive reviews. If this were possible, it could drastically reduce the amount of human work necessary for practical applications, thereby significantly decreasing the cost of the operations that require content extraction.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses an example of a table from which cell-items are extracted, and the expected assignment of row and column items for each element in the table are highlighted.

FIG. 2 discloses an example implementation of logic rules as Prolog clauses.

FIG. 3 discloses the application of logic rules R1, R2, R3, . . . over the word-elements extracted from the document's table and their cell-item assignment, obtained via a pre-existing method or human annotation.

FIG. 4 discloses an example of the computation of relative support metrics for rules over a document.

FIG. 5 discloses examples of frequent itemsets and an association rule extracted from a transactional database.

FIG. 6 discloses an example offline stage.

FIG. 7 discloses an example of frequent rule sets, with rules as referenced by single letter names in this representation.

FIG. 8 discloses an example online stage.

FIG. 9 discloses an example of the resulting structure Z for each word w∈W.

FIG. 10 discloses aspects of an example method.

FIG. 11 discloses aspects of an example computing entity operable to perform any of the disclosed methods, processes, and operations.

### DETAILED DESCRIPTION OF SOME EXAMPLE EMBODIMENTS

Embodiments of the present invention generally relate to extraction of content from documents. More particularly, at least some embodiments of the invention relate to systems, hardware, software, computer-readable media, and methods, for frequent itemset mining to determine frequent rule sets over the word-items in a new document from which content is to be extracted. Based on an assessment of which rules hold for cell item predictions for the new document, a determination may then be made as to which words in that document may require human revision.

In general, at least some example embodiments of the invention deal with information extraction from documents. Briefly stated, the problem is to extract cell-items from tables detected in a document page programmatically, allowing human reviewers to work much faster. The domain problem is that human information extraction and annotation is slow and expensive, in comparison to automated methods. However, state-of-the-art ML (machine learning) methods for those tasks are inherently faulty—they don't get 100% of the results correct all the time. Because of that, humans may need to review the results of the models. A way to determine where the models are more likely to have made mistakes is necessary.

Thus, some embodiments may operate to determine how logic rules, implemented in a logic programming framework, may be used in tandem with ML models for supporting the information extraction and annotation tasks by humans. Some embodiments are particularly focused on the extraction of cell items from tables in documents. This may be done by frequent itemset mining of the rules that hold over word-items in the training corpus, of labeled data, and then comparing those sets of rules that hold together to the rules that hold for the words in a new document. In some embodiments, this process may be used to support the semi-automated labeling of documents by identifying interpretable points of concern to human annotators.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may enable a determination to be made as to where a content extraction model is more likely to have made a mistake. As another example, an embodiment may enable a reduction, relative to conventional approaches, in the amount of human time and effort needed to evaluate content extraction results. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

In general, and as noted herein, some embodiments of the invention are directed to the information extraction problem, that is, the problem of extracting information from unstructured documents, an example of which is documents in the portable document format (pdf). Broadly stated, the problem is to extract cell-items from tables detected in a document page programmatically. This approach may enable human reviewers, who are reviewing the extracted content, to work much faster.

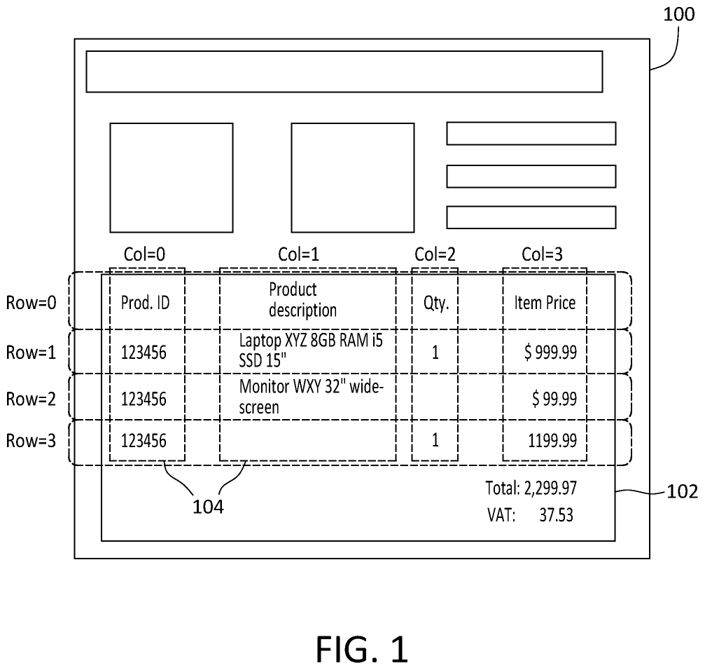

With attention now to FIG. 1, there is disclosed a representation of cell-items in a document 100 table 102. Particularly, FIG. 1 discloses an example of a table 102 from which cell-items 104 are extracted. The expected assignment of row and column items for each element in the table are highlighted by the broken lines.

For the purposes of FIG. 1, it is assumed that machine learning model(s), trained by leveraging a database of labeled documents, that is, documents whose cell-items have known, correct, row/column assignments, are in place. The resulting model(s) M work as follows: given a document, the model(s) extract a list of cell-item attribution to the words in that document that are detected within a table.

An approach that leverages an existing attribution of cell-item indexes to word-elements in a document and a set of domain-dependent logic rules to guide human annotation processes is disclosed in U.S. patent application Ser. No. 17/661,956, entitled LOGIC RULE-BASED RELATIVE SUPPORT AND CONFIDENCE FOR SEMI-STRUCTURED DOCUMENT CONTENT EXTRACTION, and filed 4 May 2022 (“'956 Application), which is incorporated herein in its entirety by this reference.

These rules may typically relate to combinations of type checks, header associations, and positional layout rules. An example of a rule is expressed by: “words with high proportion of digits can be interpreted as numerical values.” Embodiments may implement these rules into a logic programming program. Then, the rules may be applied to word-elements in the table region of the documents. The '956 Application discloses use of metrics of relative support and relative confidence of single rules to provide actionable insight to the human annotators—an indication that the model may have wrongly attributed cell-item indexes to words in a certain document. It is noted, however, that the rules relate to layout patterns, and that certain rules should hold together, in the same documents, while other rules may be independent or even mutually exclusive.

Some example embodiments may apply techniques for frequent itemset mining to determine frequent rule sets over the word-items. Then, performing the assessment of which rules hold for a new document cell-item predictions, some embodiments may determine which words in that document require human revision. Some embodiments may thus be able to provide a semantically meaningful context to the annotator of where, that is, which words, to look for which errors, that is, rules that failed.

### B. Context

In general, embodiments may employ any suitable conventional machine learning model(s) M for extracting cell-item attributions from documents. Some embodiments may employ logic rules for post-processing cell-item determinations of word-elements in documents, examples of which are disclosed in the '956 Application.

B.1 Logic Rules

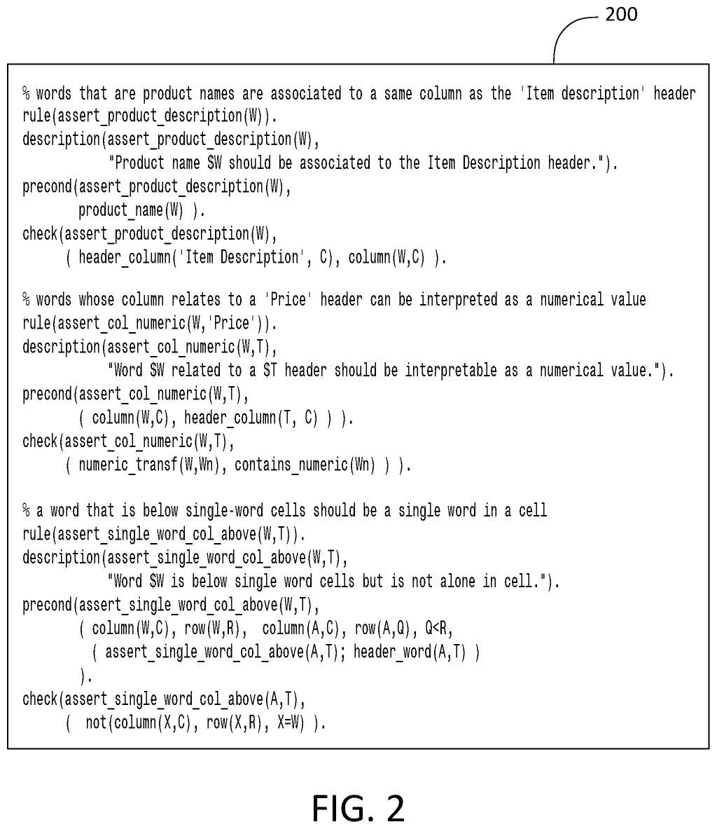

Logic rules may be applied over a word-element in a table within a document. Some of these logic rules may typically relate to: a type check (for example—“words with high proportion of digits can be interpreted as numerical values”); a header association (for example—“words that are product names are associated to a some column as the ‘Item description’ header”; a combination of both a type check and a header association (for example, “words whose column relates to a ‘Price’ header can be interpreted as a numerical value”); and, positional layout rules (for example—“all words that satisfy the some type checks as words above it should belong to same the some column,” or “a word that is below single-word cells should be a single word in a cell”). Any or all of these rules may be implemented as a set of predicates in a logic programming language, such as Prolog for example, where each rule may be defined by four clauses: (1) a rule clause, determining name and arity of the rule predicate—the examples below assume the first argument of each such predicate to be the identifier of a word-item; (2) a description clause, linking a rule to a human-readable interpretation; (3) a precond clause, determining the preconditions that must hold for the rule to be applicable for the argument word-item; (4) and, a check clause, determining clauses that must succeed and/or constraints that must hold for the rule to succeed when the preconditions are met. Example implementations 200 for some of the rules above are disclosed in FIG. 2, which discloses an example implementation of rules as Prolog clauses.

Note that in some cases, the rules to be applied by a particular embodiment may be determined by experts in the particular domain with which the embodiment is concerned. The processing of the rules may involve the orchestration of calls to the predicates defined as rule clauses. Note as well, for example, that the last rule in FIG. 2 contains a recursive precondition check. Within the logic programming paradigm, a call to a rule whose preconditions fail, will likewise fail.

In FIG. 2, the rules are determined with respect to a precondition and a check. If the precondition does not hold for a given word-item, then the rule is not considered. Otherwise, that is, if the precondition does hold, then the rule either succeeds (1) or fails (0) regarding that word-item.

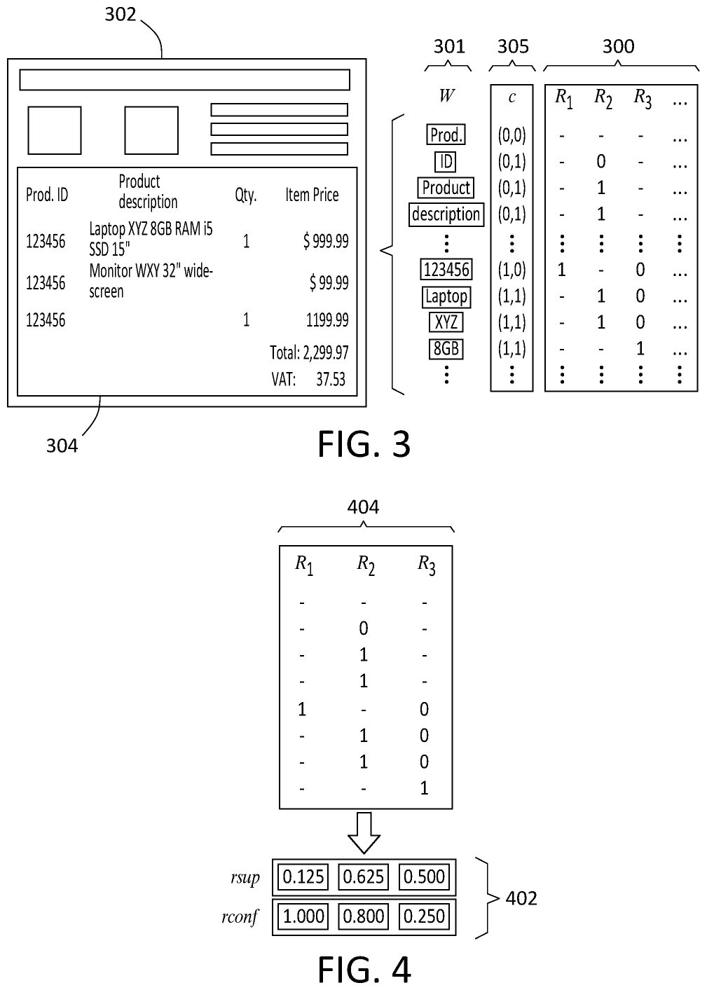

The application of the rules over a document comprises applying rules R={R1, R2, R3, . . . } over all the word-items W in that document given a cell-item indication c. That indication may originate from labels, applied by human annotators, or from predictions of machine learning models. The patterns that hold, and do not hold, on each word of that document are obtained. This is shown in FIG. 3.

Particularly, FIG. 3 discloses an application of logic rules R1, R2, R3, . . . 300 over the word-items 301 extracted from the document 302, specifically from table 304, and their cell-item assignment 305, obtained via a pre-existing method or human annotation. In the example of FIG. 3, a dash ‘-’ indicates that the rule is not applicable to that word item, that is, the precondition of the rule does not hold. A zero indicates that the precondition holds, and the check is not satisfied. Finally, a one (1) indicates that the precondition holds, and that the checks are satisfied. These various cases may form the basis of the analysis that enables some embodiments to determine which rules generally apply to a document or not. After the application of these rules, embodiments may obtain metrics of the relative support and relative confidence of each rule within each document. The relative support and confidence may be computed as follows:
(1) the relative support of a rule may be determined by the proportion of words for which the preconditions of the rule were met—formally,
rsup=|w∈R:P(R,w)|/|W|, where P(R, w) denotes the success of clause ‘precond’ for the rule R, given word w as the first argument; and
(2) the relative confidence of a rule may be determined by the proportion of words for which the check succeeded, given that the preconditions of the rule were met—formally,
rconf=|w∈R:C(R,w)|/|wεR:P(R,w)|, where C(R, w) denotes the success of clause ‘check’ for the rule R, given word w as the first argument.

An example of the metrics computed following an abridged version of the example above is shown in FIG. 4, which discloses an example of the computation of relative support metrics 402 for rules 404 over a document. In the simplified example of FIG. 4, the metrics 402 are shown as being computed over only a few words, and a few rules, for ease of explanation. In practical applications, the number of such rules, and words, may be much larger.

B.2 Association Rules and Frequent Itemsets

Association rules comprise a type of information extracted from data mining processes that describe interesting relationships among data items of a specific knowledge domain. Some example association rules are defined and described in (1) R. Agrawal and R. Srikant, “Fast Algorithms for Mining Association Rules,” in Proceedings of the VLDB Conference, 1994, and (2) A. Prado, C. Targa and A. Plastino, “Improving Direct Counting for Frequent Itemset Mining,” in Proceedings of DaWaK, 2004, both of which are incorporated herein in their respective entireties by this reference.

Market basket analysis is a typical application of association rule mining (ARM) and generally involves identifying relationships among products that are frequently bought together. To illustrate, the rule “a customer who buys beans, in general, also buys rice,” represented as {bean}⇒={rice}, is likely be extracted from a market database in Brazil. Formally, an association rule, defined over a set of items I (such as rice and beans in the illustrative example above)={i1, i2, . . . , in}, is an implication of the form X⇒Y, where X⊂I, Y⊂I, X≠∅, Y≠∅, and X∩Y=∅. Here, X is referred to as the antecedent, and Y is the consequent of the rule. In the example above, the beans are X, and the rice is Y.

Now, let D be a set of transactions (a transactional database) defined over I, where each transaction t is a subset of I(t⊆I). Then, the rule X⇒Y holds in D with support ‘s’ and confidence ‘c’ if, respectively, s % of the transactions in D contain X∪Y, and c % of the transactions in D that contain X also contain Y.

The ARM problem may be broken into two phases. Let minsup and minconf be, respectively, the user specified minimum support, and confidence. The first phase, the frequent itemset mining (FIM) phase, may comprise identifying all frequent itemsets, that is, sets of items, that occur in at least minsup % of the transactions. The second phase outputs, for each identified frequent itemset Z, all association rules A⇒B with confidence greater than or equal to minconf, such that A⊂Z, B⊂Z, and A∪B=Z. The FIM phase may demand more computational effort than the second phase.

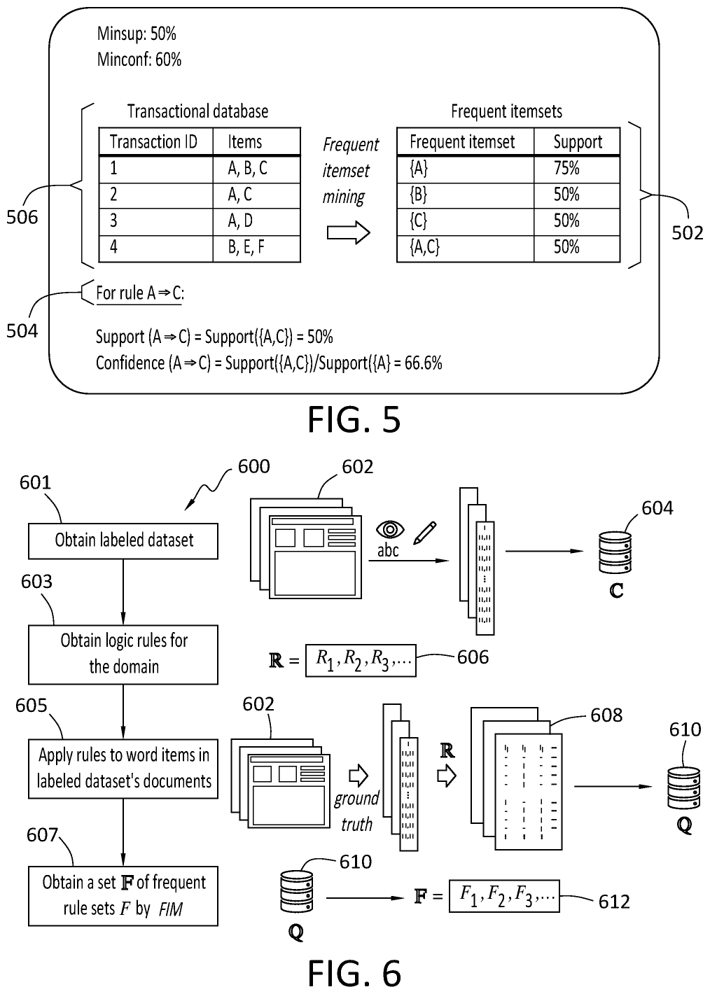

An example of frequent itemsets extracted from a transaction database, along with an example association rule is shown in FIG. 5. Particularly, FIG. 5 discloses frequent itemsets 502 and an association rule 504 extracted from a transactional database 506. Among the resulting frequent itemsets, those frequent itemsets with relatively larger number of items may be referred to as maximal itemsets. Note that, an item may appear in more than one maximal itemset—such as {A,B} and {A,C}, for example, that both include item A.

### C. Aspects of Some Example Embodiments

Some example embodiments may operate to leverage the determination of logic rules and frequent itemset mining to identify frequent rule sets. Frequent rule sets identify rules that typically hold for a same word-element in the training dataset. Example embodiments differ from the '956 Application, in which a formulation of logic rules is originally defined, and there are obtained metrics of support and confidence of a rule in comparison to itself during a supervised stage. By way of contrast, some embodiments of the present invention consider the contextual relevance of sets of rules, as in, which rules typically should hold together for a certain word element. While the approach set forth in the '956 Application is valuable and applicable to a variety of cases, it does not consider rules applied in combination and, as such, limits the results, and interpretability of results, for human-supported context extraction.

Hence, in some domains, such as those with many interrelated rules, example embodiments of the invention may be particularly useful. Some embodiments may comprise two states, namely, an offline stage, in which the rules may be exhaustively applied to the word-elements in the training dataset document tables and frequent rule sets may be computed, and an online stage, which may be applied in conjunction with the cell-item prediction process, providing insight to human annotators to target human revision of the model output. These stages are discussed in more detail below.

C.1 Offline Stage

With attention now to FIG. 6, an example implementation of an offline stage is disclosed. The offline stage may comprise a method 600, which may be performed in connection with various datasets and components.

The method 600 may begin with the obtaining 601 of a large, labeled dataset 602, which contains the ground truth of cell item assignments. This dataset is typically available as the current approach is for human labelers to compose the annotations as a result of their activity of manual information extraction (see the initial operation of the cell-item prediction approach discussed earlier). Hence this dataset 602 may typically be the same dataset used for the supervised training of cell-item prediction models. The resulting annotated dataset, that includes cell-item assignments, is stored in database [symbol] 604.

At 603, the logic rules 606 of the domain may be obtained. This may be done as described earlier herein at B.1 for example, and may require domain knowledge and specialist input to formalize the rules into an executable logic program.

Next, the method 600 may perform 605 an exhaustive procedure of applying all the logic rules 606 to the word-elements in the table regions of the documents in the ground truth dataset 602. This results in logic rule results 608 which may be stored in a database [symbol] 610, in which a record is kept of which rules hold for each word-element. Recall that, according to some embodiments at least, a rule holds if the preconditions for the application of the rule holds, and if the check succeeds. If the preconditions hold but the check fails, the rule fails and, thus, that rule may not be considered during composition of the frequent rule sets. Embodiments may disregard the instances in which the rule preconditions fail for a word—in effect, those rules are likewise not considered in the composition of the frequent rule sets.

Embodiments may then proceed to perform a process of frequent itemset mining (FIM) 607 over the rules in [symbol] 610. Typical approaches such as the ones described elsewhere herein may be used. Variations of those algorithms may be used depending on the context of execution, volume of data, and so forth. With respect to the formulation in B.2, embodiments may consider each word-element in the document corpus as a transaction in the database. Each rule that holds is an item ‘I’ in those transactions. As the frequent itemsets may comprise sets of different sizes, embodiments may track the supports of non-maximal sets as well, as is typical in FIM approaches.

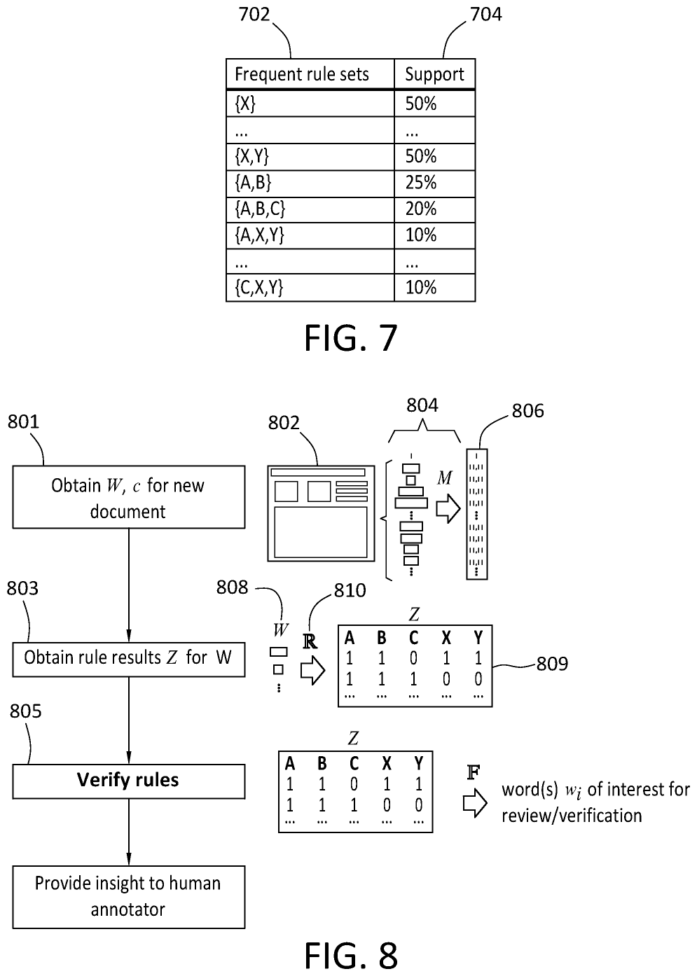

The FIM results in sets of rules and their support over the entire corpus of word-elements in the table regions of the documents in the dataset. These rules 612 are stored in a structure F. An example in one domain is disclosed in FIG. 7. Particularly, FIG. 7 discloses an example of frequent rule sets 702 and associated support levels 704. Rules are referenced by single letter names (A, B, C, X, Y) in this illustration. FIG. 7 illustrates, for example, that rules X and Y ‘hold’ in conjunction for 50% of the words in the corpus. That is, the combination of rules X and Y has a ‘support’ level, in the corpus, of 50%. By way of contrast, the combination of rules A and B has a ‘support’ level of only 20%. Note that as a consequence of the frequent itemset mining process and the parametrization of minimum acceptable support, some embodiments may not consider a rule set combination, such as A,X,Y (support level of 10%) in FIG. 7 for example, when those rules all hold together too infrequently.

C.2 Online Stage

The online stage may take place considering a new document, that is, a document not included in the training dataset, for which cell-items are to be determined. As disclosed in FIG. 8, embodiments of the online stage may comprise a method 800, which may be performed in connection with various datasets and components.

The method 800 may begin by obtaining 801, for a new document 802, the word-elements W 804 in the table region, and their respective cell-item predictions c 806, using one or more ML models. Embodiments may consider a framework in which a model, or set of models, operate to yield a cell-item prediction 806 for each word element.

Next, the method 800 may obtain 803 results Z for each word w∈W by applying the logic rules to the word-elements in the document, tracking those for which the rules hold, where, in FIG. 8, the words w∈W are denoted at 808, and logic rules at 810. This process may be similar to the tracking of the rules in the training stage, that is, considering only rules for which both the preconditions hold, and the checks succeed.

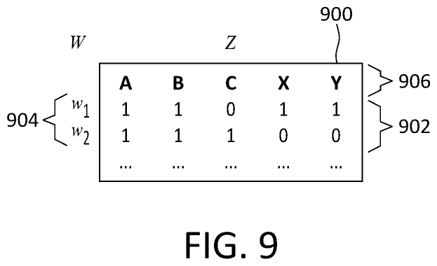

The result of 803 may be a structure Z 809 that holds the results, for each word-element, of the application of the rules, with conventional notation (1,0) for (true,false), respectively. Reference is briefly made here to FIG. 9 which discloses an example of the resulting structure Z 900 for each word w∈W. This structure 900 may be similar to the structure in FIG. 3, although the example of FIG. 9 omits c. Particularly, the example structure Z 900 holds the results 902, for each word-element 904, of the application of the rules 906, with conventional notation (1,0) for (true,false), respectively.

With continued reference now to the example of FIG. 8, and letting Z[w, R] denote whether logic rule R holds for word w, embodiments may perform a verification procedure 805 for each word-element w∈W in the document. This procedure 805 may identify rules that failed but, as indicated by other, succeeding, rules that often hold together with the rule(s) that failed, should have typically also succeeded for that word.

An example implementation of a verification procedure may be performed using the following algorithm:

```
VerifyRules(w, threshold)
For each rule r such that Z[w,r] is false
  For each maximal frequent rule sets Q such that r ∈Q: suppQ = support
    of frequent rule set Q
    Let S be Q − {r}
    If Z[w,s] = true for all s ∈S
      suppS = support of frequent rule set S
      if suppQ/suppS > threshold:
        assign w for verification with respect to rule r in the
        context of the rules in S
        //In possible embodiment: ‘break’ here
```

This algorithm may select rules that failed for the word, and consider whether the failed rule(s) is part of a large set of rules that frequently hold together for words in the domain—that is, a maximal frequent rule set.

Consider the example of word w1 in FIG. 9, and select the rule C that failed. Rule C belongs to two maximal frequent rule sets (with 3 elements each) in F: {A,B,C} and {C,X,Y} (see FIG. 7). For each of these rule sets, an embodiment may consider if the other rules in the maximal frequent rule set hold, even though C does not, that is, even though C has failed. If the rules in the set, other than the failed rule, hold, embodiments may compute the ratio between the supports of the frequent rule sets with, and without, the failed rule. This corresponds to the confidence of the association rule S⇒Q. This confidence may then be compared to a parametrized threshold to determine if the failed rule, C in this example, is of interest.

In the example, consideration may first be given to the set Q={A,B,C}. It has a suppQ in F equal to 0.20 (see FIG. 7). The rules A and B indeed hold for w1 (see FIG. 9). Hence, there is the set S={A,B} we take suppS from F as 0.25. Next, the ratio suppQ/suppS (0.2/0.25) is computed, with a result of 0.8. This indicates the confidence {A,B}⇒C (that is, the confidence of C, given both A and B). That means that for 80% of the words for which A and B held, C has held as well, in the training set (recall that suppS and suppQ are obtained from F, the structure obtained in the offline stage). That was not the case for word w1, for which, as shown in FIG. 9, C did not hold. Note that with respect to suppQ/suppS, the set Q has more rules than S, by definition. Thus, removing a rule will increase the support of a set of rules, as it may be easier to have fewer rules to hold at the same time. Thus, suppQ will be smaller than suppS, and the correct ratio is smaller/larger to obtain that fraction.

Next, the confidence, 0.8 in this case, may be compared to a threshold, which may be predetermined, based on domain expertise, and/or other considerations. In this case, because 0.8 is larger than the threshold of 0.5, the word w1 may be assigned for verification with respect to the rule C in the context of {A,B}. That is, the confidence level is sufficiently high that it is likely that the rule C was incorrectly indicated as failed. Put another way, the confidence level in this example is relatively low that rule C was correctly assessed as having failed. As such, there may be a need to verify the applicability of that rule C to word w1.

An embodiment may then proceed to select Q={C,X,Y} in the outermost loop. As rules X and Y also hold for w1 (see FIG. 9), S={X,Y} is obtained, and a ratio suppQ/suppS=0.10/0.50 (see FIG. 7)=0.20. This confidence that {X,Y}⇒C is lower than the threshold of 0.5, and the word w1 is not assigned for verification in this context.

That is, the confidence level in this example is sufficiently low that it is unlikely that the rule C was incorrectly indicated as failed. Put another way, the confidence level in this example is relatively high that rule C was correctly assessed as having failed. As such, there may be no need to verify the applicability of that rule C to word w1.

Note that even a single word assignment for human verification imposes a burden on a human annotator to have to check whether that word was assigned a correct cell-item. Hence, it may be beneficial to include a break, as indicated by a comment in the algorithm above, to stop the procedure as soon as one indication is found. This may prevent the approach from providing the most-significant contextual information, however. That is, there may be another set S for which a more semantically relevant frequent rule set is available, other than the first one found.

The triple defined by w, r, S gives the word (w), the rule that failed (r), and the context (S) in which the rule r should have succeeded. Hence, embodiments may be able to inform the human annotator so that his attention is targeted at that word, and in the context of those rule(s). The details of the annotation interface used by the human annotator may depend on the tool used by the human annotator for the information extraction process depend on the concrete use-case. In some embodiments at least, the description clauses of the rules may be used to compose a message in natural language (NL).

### D. Further Discussion

As will be apparent from this disclosure, example embodiments of the invention may possess a variety of features and advantages. For example, some embodiments are directed to a process to leverage a selected set of logic rules that encode typical patterns over lists of word-elements extracted from document tables. The process may be used offline to determine the frequent rule sets, which may typically hold for the same word-elements in the training data. Further, the same or similar process may then be used online to determine, for each word in a new document that was not part of the training data, whether one such rule that typically holds in the context of other rules has failed when those succeeded. This process may then be used to support the semi-automated labeling of documents by identifying interpretable points of concern to human annotators.

### E. Example Methods

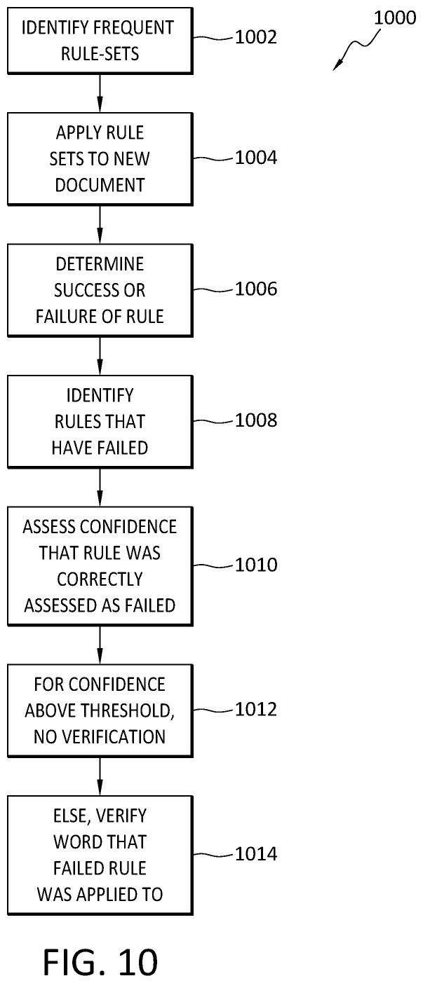

It is noted with respect to the disclosed methods, including the example method of FIG. 10, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 10, an example method 1000 according to some embodiments is disclosed that may be used in content extraction processes as applied to documents, such as unstructured documents for example. The method 1000 may begin 1002 with the identification of rule sets, or groupings of rules, that tend to appear relatively frequently and that bear a relationship with each other in terms of when they apply to the words of a document. This operation 1002 may be performed as part of a training process, using ground truth data, that is, training data, in the form of annotated, or labeled, documents.

After the training has been completed, the rule sets may be applied 1004 to a new document, or documents, not part of the training data. Next, a determination may be made 1006 as to whether or not a rule in a rule set has failed, that is, whether or not the rule has been determined to be applicable to a word. Any failed rule(s) may then be identified 1008.

Once any failed rule(s) have been identified 1008, the confidence that the rule was correctly identified as failed may then be assessed 1010. If there is a relatively high confidence 1012, such as above a defined threshold, that the rule was correctly identified as having failed, then there may be no need to verify the word(s) to which the rule was applied to. On the other hand, if there is relatively low confidence that the rule was correctly identified as having failed—or relatively high confidence that the rule was incorrectly identified as having failed—then a verification 1014 of the word(s) to which the rule was applied may be performed. This verification may comprise identifying those words to a human operator so as to enable the human operator to make a final determination as to whether those words were assigned to the correct cell-item or not.

### F. Further Example Embodiments

Following are some further example embodiments of the invention. These are presented only by way of example and are not intended to limit the scope of the invention in any way.

Embodiment 1. A method, comprising: receiving a rule-set, comprising a combination of rules, that was determined to occur in a set of ground truth documents; applying the rule-set to a new document that was not included in the set of ground truth documents; determining whether or not a rule in the rule-set succeeded or failed when applied to a word in the new document, and when the rule is determined to have failed, identifying the failed rule; identifying a confidence level in the determination that the rule failed; and when the confidence level is below a threshold confidence level, identifying the word, to which the failed rule was applied, as a candidate for verification by a human.

Embodiment 2. The method as recited in embodiment 1, wherein the new document is an unstructured document.

Embodiment 3. The method as recited in any of embodiments 1-2, wherein the confidence level is a function of an extent to which rules in the rule-set hold for words in the new document.

Embodiment 4. The method as recited in any of embodiments 1-3, wherein the rule is considered to hold for a word in the new document if preconditions for the rule hold, and if a check concerning that rule is satisfied, wherein the check comprises determining clauses that must succeed and/or constraints that must hold for the rule to succeed when the preconditions are met.

Embodiment 5. The method as recited in any of embodiments 1-4, wherein some of the rules in the rule-set are known to hold together for some words.

Embodiment 6. The method as recited in any of embodiments 1-5, wherein the confidence level is determined based on a level of support in the ground truth documents for the rule set when the failed rule is excluded, and also based on a level of support in the ground truth documents for the rule set when the failed rule is included.

Embodiment 7. The method as recited in any of embodiments 1-6, wherein the verification comprises a determination whether or not a cell-item of a table in the new document was correctly predicted for the word.

Embodiment 8. The method as recited in any of embodiments 1-7, wherein the rule-set is employed with the new document based on a frequency with which the rule-set was determined to apply to the set of ground truth documents.

Embodiment 9. The method as recited in any of embodiments 1-8, wherein the rules are included in the rule-set due to a determination that the rules hold together for some words in the set of ground truth documents.

Embodiment 10. The method as recited in any of embodiments 1-9, further comprising performing a content extraction process that includes using the rules in the rule-set to assign cell-items to the words in the new document.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

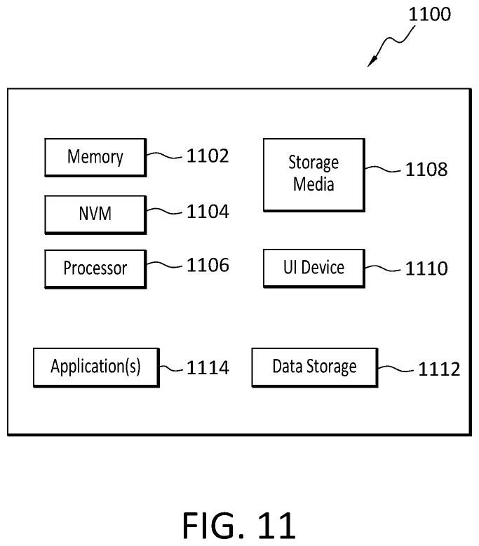

With reference briefly now to FIG. 11, any one or more of the entities disclosed, or implied, by FIGS. 1-10 and/or elsewhere herein, may take the form of, or include, or be implemented on, or hosted by, a physical computing device, one example of which is denoted at 1100. As well, where any of the aforementioned elements comprise or consist of a virtual machine (VM), that VM may constitute a virtualization of any combination of the physical components disclosed in FIG. 11.

In the example of FIG. 11, the physical computing device 1100 includes a memory 1102 which may include one, some, or all, of random access memory (RAM), non-volatile memory (NVM) 1104 such as NVRAM for example, read-only memory (ROM), and persistent memory, one or more hardware processors 1106, non-transitory storage media 1108, UI (user interface) device 1110, and data storage 1112. One or more of the memory components 1102 of the physical computing device 1100 may take the form of solid state device (SSD) storage. As well, one or more applications 1114 may be provided that comprise instructions executable by one or more hardware processors 1106 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a rule-set, comprising a combination of rules, that was determined to occur in a set of ground truth documents;
applying the rule-set to a new document that was not included in the set of ground truth documents;
determining whether or not a rule in the rule-set succeeded or failed when applied to a word in the new document, and when the rule is determined to have failed, identifying the failed rule;
identifying a confidence level in the determination that the rule failed; and
when the confidence level is below a threshold confidence level, identifying the word, to which the failed rule was applied, as a candidate for verification by a human.

2. The method as recited in claim 1, wherein the new document is an unstructured document.

3. The method as recited in claim 1, wherein the confidence level is a function of an extent to which rules in the rule-set hold for words in the new document.

4. The method as recited in claim 1, wherein the rule is considered to hold for a word in the new document if preconditions for the rule hold, and if a check concerning that rule is satisfied, wherein the check comprises determining clauses that must succeed and/or constraints that must hold for the rule to succeed when the preconditions are met.

5. The method as recited in claim 1, wherein some of the rules in the rule-set are known to hold together for some words.

6. The method as recited in claim 1, wherein the confidence level is determined based on a level of support in the ground truth documents for the rule set when the failed rule is excluded, and also based on a level of support in the ground truth documents for the rule set when the failed rule is included.

7. The method as recited in claim 1, wherein the verification comprises a determination whether or not a cell-item of a table in the new document was correctly predicted for the word.

8. The method as recited in claim 1, wherein the rule-set is employed with the new document based on a frequency with which the rule-set was determined to apply to the set of ground truth documents.

9. The method as recited in claim 1, wherein the rules are included in the rule-set due to a determination that the rules hold together for some words in the set of ground truth documents.

10. The method as recited in claim 1, further comprising performing a content extraction process that includes using the rules in the rule-set to assign cell-items to the words in the new document.

11. A non-transitory storage medium having stored therein instructions that are executable by one or more hardware processors to perform operations comprising:
receiving a rule-set, comprising a combination of rules, that was determined to occur in a set of ground truth documents;
applying the rule-set to a new document that was not included in the set of ground truth documents;
determining whether or not a rule in the rule-set succeeded or failed when applied to a word in the new document, and when the rule is determined to have failed, identifying the failed rule;
identifying a confidence level in the determination that the rule failed; and
when the confidence level is below a threshold confidence level, identifying the word, to which the failed rule was applied, as a candidate for verification by a human.

12. The non-transitory storage medium as recited in claim 11, wherein the new document is an unstructured document.

13. The non-transitory storage medium as recited in claim 11, wherein the confidence level is a function of an extent to which rules in the rule-set hold for words in the new document.

14. The non-transitory storage medium as recited in claim 11, wherein the rule is considered to hold for a word in the new document if preconditions for the rule hold, and if a check concerning that rule is satisfied, wherein the check comprises determining clauses that must succeed and/or constraints that must hold for the rule to succeed when the preconditions are met.

15. The non-transitory storage medium as recited in claim 11, wherein some of the rules in the rule-set are known to hold together for some words.

16. The non-transitory storage medium as recited in claim 11, wherein the confidence level is determined based on a level of support in the ground truth documents for the rule set when the failed rule is excluded, and also based on a level of support in the ground truth documents for the rule set when the failed rule is included.

17. The non-transitory storage medium as recited in claim 11, wherein the verification comprises a determination whether or not a cell-item of a table in the new document was correctly predicted for the word.

18. The non-transitory storage medium as recited in claim 11, wherein the rule-set is employed with the new document based on a frequency with which the rule-set was determined to apply to the set of ground truth documents.

19. The non-transitory storage medium as recited in claim 11, wherein the rules are included in the rule-set due to a determination that the rules hold together for some words in the set of ground truth documents.

20. The non-transitory storage medium as recited in claim 11, wherein the operations further comprise performing a content extraction process that includes using the rules in the rule-set to assign cell-items to the words in the new document.
